(19) United States
(12) Patent Application Publication
(10) Pub. No.: US 2026/0085567 A1
(43) Pub. Date: Mar. 26, 2026

(54) DOOR OPENING AND CLOSING DEVICE AND ELECTRICAL APPARATUS

(71) Applicants: HEFEI MIDEA REFRIGERATOR CO., LTD., HEFEI (CN); HEFEI HUALING CO., LTD., HEFEI (CN); MIDEA GROUP CO., LTD., FOSHAN (CN)

(72) Inventors: Yerui FENG, HEFEI (CN); Bo PENG, HEFEI (CN); Bing SHI, HEFEI (CN); Jinguo YUAN, HEFEI (CN); Chuandong WANG, HEFEI (CN); Shenghao QI, HEFEI (CN); Ronghai CHEN, HEFEI (CN); Zhuohua JIANG, HEFEI (CN); Xiuliang FU, HEFEI (CN); Yafei ZHU, HEFEI (CN)

(21) Appl. No.: 19/110,107

(22) PCT Filed: Jun. 26, 2023
(86) PCT No.: PCT/CN2023/102390

§ 371 Date: Mar. 10, 2025

(30) Foreign Application Priority Data
Sep. 20, 2022 (CN) 202211153406.4

(51) Int. Cl. E05F 15/63

(52) U.S. Cl. CPC E05F 15/63; E05Y 2201/712; E05Y 2900/30

(57) ABSTRACT

The door opening and closing device is used to open a door body disposed on a main body. The door opening and closing device includes: a base, a driving mechanism, a linkage gear and a door rotation mechanism. The linkage gear is rotatably disposed on the base and is in transmission connection with the driving mechanism. The door rotation mechanism is disposed between the linkage gear and the base. An end of the door rotation mechanism is connected to the linkage gear, and another end of the door rotation mechanism is connected to the door body. In a condition that the driving mechanism drives the linkage gear to rotate, the door rotation mechanism drives the door body to rotate relative to the main body to open or close the door body.

### CROSS-REFERENCES TO RELATED APPLICATIONS

The present disclosure is a national phase application of International Application No. PCT/CN2023/102390, filed Jun. 26, 2023, which claims priority to the Chinese patent application No. 202211153406.4, filed on Sep. 20, 2022, the entire contents of which are incorporated herein by reference.

### FIELD

The disclosure belongs to the field of electrical apparatus, and in particular to a door opening and closing device and an electrical apparatus.

### BACKGROUND

With the improvement of living standards, electrical apparatuses such as refrigerators, dishwashers and disinfection cabinets have become widely used in lives of people. In order to maintain a sealing performance of the above-mentioned electrical apparatuses, an adsorption structure is usually provided between a main body and a door body thereof, or negative pressure is maintained within the main body, to stably fix the door body to the main body. Although a related performance of the electrical apparatus is improved in this way, a difficulty of opening the door body is also increased to a certain extent. Since a larger force is usually required to open the door body, it is inconvenient to use. In the related art, a door opening and closing device includes a door rotation mechanism and a driving mechanism. The door rotation mechanism is connected to the driving mechanism and the door body, respectively. The door rotation mechanism is driven through the driving mechanism to open the door body. This layout will result in a larger overall thickness of the door opening and closing device.

### SUMMARY

The disclosure intends to at least to a certain extent solve a problem of an overall thickness of a door opening and closing device being relatively large. To this end, a door opening and closing device and an electrical apparatus are provided according to one or more embodiments of the disclosure.

According to one embodiment of the disclosure, a door opening and closing device is provided, which is used to open a door body provided on a main body. The door opening and closing device may include:
a base;
a driving mechanism;
a linkage gear rotatably disposed on the base and in transmission connection with the driving mechanism;
a door rotation mechanism disposed between the linkage gear and the base, an end of the door rotation mechanism being connected to the linkage gear, and another end of the door rotation mechanism being connected to the door body, and in a condition that the driving mechanism drives the linkage gear to rotate, the door rotation mechanism drives the door body to rotate relative to the main body, to open or close the door body.

According to another embodiment of the disclosure, an electrical apparatus is provided, including a door body a main body, and the door opening and closing device. The door body is rotatably connected to the main body, the door opening and closing device being installed on the main body, the door rotation mechanism being connected to the door body.

### BRIEF DESCRIPTION OF THE DRAWINGS

In order to more clearly illustrate the embodiments of the disclosure, the following briefly introduces the accompanying drawings required for describing the embodiments. The accompanying drawings in the following description only illustrate some embodiments of the disclosure, and other accompanying drawings can also be obtained based on these accompanying drawings.

FIG. 1 shows a schematic structural diagram of an electrical apparatus with a closed door body according to an embodiment of the disclosure.

FIG. 2 shows a schematic structural diagram of the electrical apparatus with an opened door body according to an embodiment of the disclosure.

FIG. 3 is a schematic structural diagram showing cooperations of a door ejection member and a door rotation mechanism with a linkage gear of a door opening and closing device according to an embodiment of the disclosure.

FIG. 4 shows a schematic structural diagram of the linkage gear of the door opening and closing device according to an embodiment of the disclosure.

FIG. 5 shows an exploded view of the door rotation mechanism of the door opening and closing device according to an embodiment of the disclosure.

FIG. 6 shows a partial enlarged view of a portion indicated by V in FIG. 5 of the door opening and closing device according to an embodiment of the disclosure.

FIG. 7 shows a schematic structural diagram of a door opening and closing device mounted on a main body according to an embodiment of the disclosure.

In the accompanying drawings, corresponding relationships between reference signs and component names are as follows:
10, electrical apparatus; 11, door opening and closing device; 12, main body; 13, door body;
100, driving mechanism;
300, linkage gear; 310, abutting-holding portion; 332, rotation center; 334, first connection point; 336, second connection point; 338, third connection point; 361, first abutting-holding surface; 362, second abutting-holding surface; 363, installation groove; 364, fixing slot; 370, transmission tooth;
400, door rotation mechanism; 410, front connecting rod; 413, first connecting portion; 414, connecting groove; 415, first fixing plate; 416, second fixing plate; 417, connecting plate; 418, first connecting hole; 420, rear connecting rod; 424, second connecting portion; 425, second connecting hole; 450, connecting member; 452, rotating shaft; 470, reset member;
500, door ejection member;
600, suspension mechanism;
900, housing; 910, upper cover; 916, throughout opening; 920, base; 930, accommodating cavity.

### DETAILED DESCRIPTION OF THE DISCLOSURE

The embodiments of the disclosure will be clearly and completely described below with reference to the accompanying drawings in the embodiments of the disclosure. The described embodiments are only some embodiments, rather than all embodiments of the disclosure.

It should be noted that all directional indications in the embodiments of the disclosure are only configured to explain the relative position relationship, movement status and so on among the components in a specific posture. If the specific posture changes, the directional indication will also change accordingly.

In the disclosure, unless otherwise clearly stipulated and limited, the terms “connected”, “fixed” and so on should be understood in a broad sense. For example, “fixed” can be a fixed connection, a detachable connection, or an integral connection; it can be a mechanical connection or an electrical connection; it can be a direct connection or an indirect connection through an intermediate medium; it can be an internal connection of two elements or an interaction relationship between two elements, unless otherwise clearly limited. The specific meanings of the above terms in the embodiments of the disclosure can be understood according to specific circumstances.

In addition, descriptions such as “first”, “second” and so on in the disclosure are only used for descriptive purposes and cannot be understood as indicating or implying relative importance thereof or implicitly indicating the number of the indicated features. Therefore, the features defined as “first” or “second” may explicitly or implicitly include at least one features. In addition, the embodiments can be combined with one another, but the combined solutions must be based on that they can be implemented. When the combined solutions are contradictory or cannot be realized, it should be considered that such combined solutions do not exist, and are not within the protection scope sought for by the present disclosure.

With the improvement of living standards, electrical apparatuses such as refrigerators, dishwashers and disinfection cabinets have become widely used in lives of people. In order to maintain a sealing performance of the above-mentioned electrical apparatuses, an adsorption structure is usually provided between a main body and a door body thereof or negative pressure is maintained within the main body, to stably fix the door body to the main body. Although a related performance of the electrical apparatus is improved in this way, a difficulty of opening the door body is also increased to a certain extent. Since a larger force is usually required to open the door body, it is inconvenient to use. In the related art, the door opening and closing device includes a door rotation mechanism, a driving mechanism, and a linkage gear. The door opening and closing device is connected to a door body through the door rotation mechanism to implement the closing or opening of the door body. The door rotation mechanism will be disposed above the linkage gear, resulting in a greater thickness of entire door opening and closing device. The door opening and closing device provided according to an embodiment of the disclosure can ameliorate the above problem. The door rotation mechanism of the door opening and closing device according to an embodiment of the disclosure is disposed below the linkage gear, to be capable of reducing the thickness of the entire door opening and closing device and improving an integration degree of the door opening and closing device.

The disclosure is described below with reference to the accompanying drawings and embodiments.

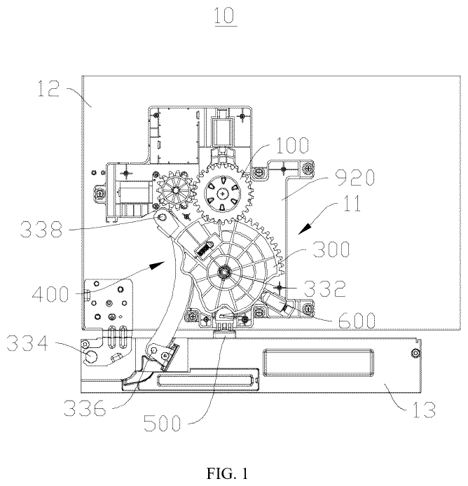

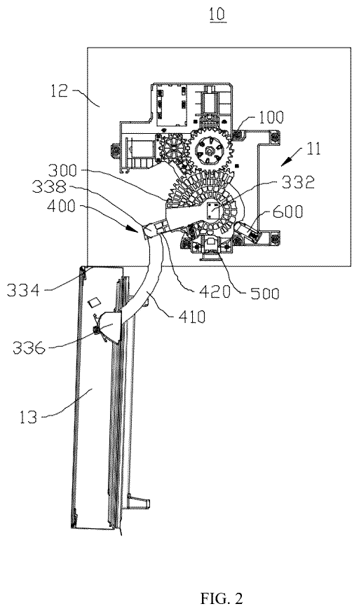

As shown in FIG. 1 and FIG. 2. A door opening and closing device 11 is provided according to one or more embodiments of the disclosure. A thickness of the door opening and closing device 11 can be reduced and an integration degree of the door opening and closing device 11 can be improved.

In one or more embodiments of the disclosure, the door opening and closing device 11 may include: a base 920, a driving mechanism 100, a linkage gear 300 and a door rotation mechanism 400. The linkage gear 300 is rotatably disposed on the base 920 and is in transmission connection with the driving mechanism 100. The door rotation mechanism 400 is disposed between the linkage gear 300 and the base 920. An end of the door rotation mechanism 400 is connected to the linkage gear 300, and another end of the door rotation mechanism 400 is connected to the door body 13. In a condition that the driving mechanism 100 drives the linkage gear 300 to rotate, the door rotation mechanism 400 drives the door body 13 to rotate relative to the main body 12 to open or close the door body 13.

In one or more embodiments of the disclosure, an end of the door rotation mechanism 400 is connected to the linkage gear 300, and another end of the door rotation mechanism 400 is connected to the door body 13. In a condition that the driving mechanism 100 drives the linkage gear 300 to rotate, the linkage gear 300 drives the door rotation mechanism 400 to rotate. The door rotation mechanism 400 drives the door body 13 to rotate relative to the main body 12 to open or close the door body 13.

For the convenience of description, a rotation direction of the linkage gear 300 that can open the door body 13 is defined as rotating forward. If the door opening and closing device 11 receives a door opening signal, a driving mechanism 100 drives the linkage gear 300 to rotate forward, and the door rotation mechanism 400 can follow the linkage gear 300 to rotate forward, to open the door body 13. If the door opening and closing device 11 receives a door closing signal, the driving mechanism 100 drives the linkage gear 300 to rotate reversely, and the door rotation mechanism 400 can rotate reversely with the linkage gear 300, to close the door body 13.

In some embodiments, the door opening signal may be triggered by a user or by the electrical apparatus 10 itself. In some embodiments, the door closing signal may be triggered by a user or by the electrical apparatus 10 itself.

In an embodiment of the disclosure, the door rotation mechanism 400 is disposed between the linkage gear 300 and the base 920, and thus, in comparison with that the door rotation mechanism 400 is disposed above the linkage gear 300, a space occupied by the door rotation mechanism 400 in a thickness direction can be reduced, to reduce a thickness of the entire door opening and closing device 11, and further improve an integration degree of the door opening and closing device 11.

In other embodiments of the disclosure, during the linkage gear 300 drives the door rotation mechanism 400 to rotate, the door rotation mechanism 400 is disposed between the linkage gear 300 and the base 920. The linkage gear 300 and the base 920 can limit the door rotation mechanism 400 from two sides of the door rotation mechanism 400, to enable the door rotation mechanism 400 to rotate in a gap between the linkage gear 300 and the base 920 to open or close the door body 13. The linkage gear 300 and the base 920 limit the door rotation mechanism 400 from two sides of the door rotation mechanism 400, and thus, a risk of the door rotation mechanism 400 separating from the linkage gear 300 can be reduced, and a transmission stability of the linkage gear 300 and the door rotation mechanism 400 can be improved.

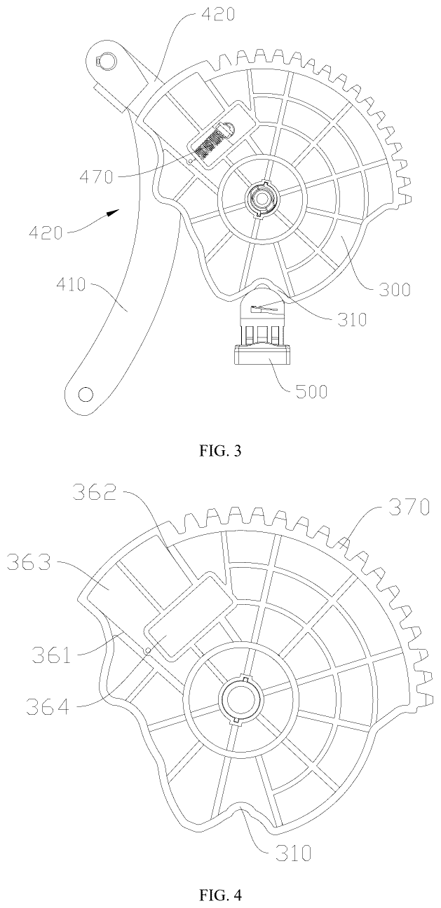

As shown in FIG. 3 and FIG. 4, in some embodiments, the linkage gear 300 is provided with an installation groove 363 on a side facing the base 920. The door rotation mechanism 400 is installed in the installation groove 363.

The door rotation mechanism 400 is disposed in the installation groove 363. The base 920 is disposed close to an opening of the installation groove 363. The base 920 can play a certain role of enclosing the installation groove 363 to prevent the door rotation mechanism 400 from separating from the installation groove 363. Thus, the door rotation mechanism 400 is prevented from falling off from the linkage gear 300. A failure of transmission between the linkage gear 300 and the door rotation mechanism 400 is prevented.

It is easily understood that, as for that the base 920 is disposed close to the opening of the installation groove 363 to prevent the door rotation mechanism 400 from separating from the installation groove 363, it is not necessary for the base 920 to be disposed at the opening to completely enclose the installation groove 363. A certain distance can be provided between the base 920 and the side of the linkage gear 300 close to the base 920. Such distance only needs to be smaller than a thickness of the door rotation mechanism 400, which can also prevent the door rotation mechanism 400 from falling off from the installation groove 363.

A shape and dimension of the installation groove 363 can be set according to specific functions of the door opening and closing device 11. If a rotation of the linkage gear 300 and a door opening operation of the door rotation mechanism 400 are implemented simultaneously, a width of the installation groove 363 may be the same as a width of a portion of the door rotation mechanism 400 that is disposed in the installation groove 363. If the door opening operation of the door rotation mechanism 400 is required to be later than the rotation of the linkage gear 300, the width of the installation groove 363 can be set to be larger than the width of the portion of the door rotation mechanism 400 that is disposed in the installation groove 363. When the driving mechanism 100 drives the linkage gear 300 to rotate, the linkage gear 300 can rotate first, and then the door rotation mechanism 400 can follow the linkage gear 300 to rotate.

In some embodiments, the door rotation mechanism 400 is disposed in the installation groove 363 to enable the door rotation mechanism 400 to be partially accommodated on the linkage gear 300, to further reduce a thickness of the entire door opening and closing device 11, and improve an integration degree of the door opening and closing device 11.

In some embodiments, a width of the installation groove 363 may be greater than a width of the door rotation mechanism 400.

It should be explained that the width of the installation groove 363 being greater than the width of the door rotation mechanism 400 indicates that the width of the installation groove 363 is greater than the width of the portion of the door rotation mechanism 400 that is located in the installation groove 363. During the driving mechanism 100 drives the linkage gear 300 to rotate, since the width of the installation groove 363 is greater than the width of the portion of the door rotation mechanism 400 that is in the installation groove 363, a certain amount of movement space is provided in the installation groove 363. After the linkage gear 300 is driven, the linkage gear 300 rotates first. When one of sides of the installation groove 363 abuts against and holds the door rotation mechanism 400 as the linkage gear 300 rotates, the door rotation mechanism 400 is pushed to rotate with the linkage gear 300 to open the door body 13.

In some embodiments, the linkage gear 300 may have a first abutting-holding surface 361. In a condition that the driving mechanism 100 drives the linkage gear 300 to rotate, the linkage gear 300 rotates relative to the door rotation mechanism 400 until the first abutting-holding surface 361 abuts against and holds the door rotation mechanism 400, and in turn the linkage gear 300 pushes the door rotation mechanism 400 to rotate to open the door body 13.

The door rotation mechanism 400, under an initial condition, is at a certain distance from the first abutting-holding surface 361. After the driving mechanism 100 receives the door opening signal, the driving mechanism 100 drives the linkage gear 300 to rotate forward, and the linkage gear 300 rotates relative to the door rotation mechanism 400. When the first abutting-holding surface 361 abuts against and holds the door rotation mechanism 400 as the linkage gear 300 rotates, the linkage gear 300 pushes the door rotation mechanism 400 to rotate to open the door body 13.

That is to say, the linkage gear 300 and the door rotation mechanism 400 rotate asynchronously. During a period of time after the driving mechanism 100 is just activated, the door rotation mechanism 400 does not rotate. The driving mechanism 100, when just activated, may be unstable, and thus if the driving mechanism 100 directly drives the door rotation mechanism 400 to rotate, it is possible that the door body 13 cannot be opened due to insufficient driving force, resulting in the damage of the door rotation mechanism 400. In a condition that the driving mechanism 100, after activated for a period of time, drives the door rotation mechanism 400 to rotate, a transmission stability of the door rotation mechanism 400 can be improved and a stability of opening a door can be improved.

In order to improve a sealing effect between the main body 12 and the door body 13 when the door body 13 is closed on the main body 12, the door body 13 is usually pressed onto the main body 12 with a larger pressure, or the door body 13 is adsorbed onto the main body 12 through an adsorption structure. There is a large adsorption force between the door body 13 and the main body 12, and thus a larger force is required for separating the door body 13 from the main body 12 when the door body 13 needs to be opened. In order to reduce the adsorption force between the door body 13 and the main body 12 which needs to be overcome by the door rotation mechanism 400 at a moment of opening a door, an abutting-holding portion 310 and a door ejection member 500 may be provided on the linkage gear 300. In a condition that the linkage gear 300 rotates, the abutting-holding portion 310 can push the door ejection member 500 to move relative to the main body 12, to eject the door body 13 open. After the door ejection member 500 ejects the door body 13 open, the door rotation mechanism 400 drives the door body 13 to continue to rotate, to open the door body 13.

The abutting-holding portion 310 disposed on the linkage gear 300 directly acts on the door ejection member 500, and thus the door ejection member 500 can quickly eject the door body 13 open, to reduce the number of components of a door ejection mechanism. An integration degree of the door opening and closing device 11 can also be improved.

That is to say, there is a distance between the first abutting-holding surface 361 and the door rotation mechanism 400 under an initial condition, during the linkage gear 300 rotating past this distance, the linkage gear 300 drives, through the abutting-holding portion 310, the door ejection member 500 to eject the door body 13 open. Thus, a door ejection operation and a door rotation operation are not performed at the same time. The linkage gear 300 first drives the door ejection member 500 to eject the door body 13 open, and then drives, through the door rotation mechanism 400, the door body 13 to continue to rotate, to pen the door body 13.

A complete process of door opening is as follows. After the driving mechanism 100 receives the door opening signal, the driving mechanism 100 drives the linkage gear 300 to rotate. Since there is a certain distance between the first abutting-holding surface 361 and the door rotation mechanism 400, the door rotation mechanism 400 is stationary and does not rotate with the linkage gear 300. At this time, the linkage gear 300 drives, through the abutting-holding portion 310, the door ejection member 500 to move in a direction approaching the door body 13. The door body 13 is first ejected to open by the door ejection member 500. After the door body 13 is ejected to open by the door ejection member 500, the first abutting-holding surface 361 is rotated to abut against and hold the door rotation mechanism 400.

In other embodiments, an other door ejection way may be selected. For example, a door ejection member 500 is directly protruded on the linkage gear 300, and the door body 13 is directly ejected to open by the door ejection member 500 during a rotation of the linkage gear 300. Similarly, there is a distance between the first abutting-holding surface 361 and the door rotation mechanism 400 under an initial condition, during the linkage gear 300 rotating past this distance, the linkage gear 300 drives, through the abutting-holding portion 310, the door ejection member 500 to eject the door body 13 open.

It should be noted that, a circle can be defined with a rotation center 332 of the linkage gear 300 as a center and any length less than a radius of the linkage gear 300 as the radius. A length of projection of the door rotation mechanism 400 and the installation groove 363 on the circle is the width referred to in the disclosure. A length of the installation groove 363 refers to a length along a radial direction of the linkage gear 300.

In some embodiments, the first abutting-holding surface 361 may be disposed on a side wall of the installation groove 363. When the linkage gear 300 is not provided with the installation groove 363, the first abutting-holding surface 361 may be provided on a structure protruding on the linkage gear 300, to be capable of abutting against the door rotation mechanism 400 and pushing the door rotation mechanism 400 to rotate along with the linkage gear 300.

In some embodiments, the linkage gear 300 may also have a second abutting-holding surface 362 spaced apart from the first abutting-holding surface 361. The door rotation mechanism 400 may be disposed between the first abutting-holding surface 361 and the second abutting-holding surface 362. The door opening and closing device 11 also includes a reset member 470, which is connected to the linkage gear 300 and the door rotation mechanism 400 respectively. In a condition that the linkage gear 300 stops rotating or rotates reversely, the reset member 470 drives the door rotation mechanism 400 to move in a direction away from the first abutting-holding surface 361, to reset the door rotation mechanism 400 to the second abutting-holding surface 362.

When the linkage gear 300 rotates under an action of an driving force of the driving mechanism 100, since the door rotation mechanism 400 does not move with the linkage gear 300, the reset member 470 is stretched until the first abutting-holding surface 361 abuts against and holds the door rotation mechanism 400 to make the door rotation mechanism 400 to rotate with the linkage gear 300 to push the door body 13. After the door body 13 is opened, the driving mechanism 100 stops working, and the reset member 470, under an action of its own restoring force, drives the door rotation mechanism 400 to move in a direction away from the first abutting-holding surface 361 until the door rotation mechanism 400 abuts against and holds the second abutting-holding surface 362, to make the door rotation mechanism 400 to be reset to where the second abutting-holding surface 362 is located.

In a direction rotating forward of the linkage gear 300, the second abutting-holding surface 362 is disposed in front of the first abutting-holding surface 361. Under an initial condition, the door rotation mechanism 400 is disposed close to the second abutting-holding surface 362. In a process of the driving mechanism 100 driving the linkage gear 300 to rotate, since the door rotation mechanism 400 is disposed close to the second abutting-holding surface 362, the door rotation mechanism 400 will not rotate with the linkage gear 300 at the beginning. In this process, due to a rotation of the linkage gear 300, the reset member 470 will be stretched. After the reset member 470 is stretched to an extreme, the reset member 470 will pull the door rotation mechanism 400 to rotate, and thus the door rotation mechanism 400 can further open the door body 13. During the reset member 470 pulls the door rotation mechanism 400 to rotate, the door rotation mechanism 400 moves in a direction approaching the second abutting-holding surface 362 under an action of the restoring force of the reset member 470. That is, during the door rotation mechanism 400 opens the door, the door rotation mechanism 400 always moves in the direction approaching the second abutting-holding surface 362. After the door rotation mechanism 400 stops moving, the door rotation mechanism 400 is disposed close to the second abutting-holding surface 362.

After the door body 13 is opened, if the driving mechanism 100 receives a door closing signal, the driving mechanism 100 drives the linkage gear 300 to rotate reversely. The second abutting-holding surface 362 abuts against and holds the door rotation mechanism 400, to drive the door rotation mechanism 400 to rotate reversely to close the door body 13.

In addition to the door being automatically closed, the door can also be closed manually. A process of closing the door manually is opposite to the above process. A user pushes the door body 13, and the door body 13 drives the door rotation mechanism 400 to rotate. The reset member 470 will be stretched. After the reset member 470 is stretched to an extreme, the reset member 470 will retract, to make the door rotation mechanism 400 to always move in the direction approaching the second abutting-holding surface 362. After the door body 13 is closed onto the main body 12, other structures such as the door rotation mechanism 400 can be completely reset.

The second abutting-holding surface 362 is disposed on a side wall of the installation groove 363 away from the first abutting-holding surface 361. Similarly, if, in other embodiments, the installation groove 363 is not provided on the linkage gear 300, the second abutting-holding surface 362 may be provided on a certain structure protruding on the linkage gear 300, as long as it is ensured that the first abutting-holding surface 361 and the second abutting-holding surface 362 can be provided opposite to each other. A gap between the first abutting-holding surface 361 and the second abutting-holding surface 362 may also be regarded as the installation groove 363.

In some embodiments, a fixing slot 364 is disposed on the linkage gear 300. The reset member 470 is disposed in the fixing slot 364.

The reset member 470 is disposed in the fixing slot 364. The fixing slot 364 is disposed on the linkage gear 300. It is equivalent to the reset member 470 being directly disposed on the linkage gear 300, which can reduce an occupied space of the reset member 470 while the reset member 470 can play a role of resetting.

In an embodiment, the fixing slot 364 is disposed on a bottom wall of the installation groove 363. A position of the installation groove 363 can be utilized for disposing the reset member 470, to be capable of reducing the space occupied by the reset member 470. A width of the fixing slot 364 may be equal to a width of the installation groove 363. A length of the reset member 470 can be increased to improve a stretching amount and a retracting amount of the reset member 470, to enable the reset member 470 to quickly reset the door rotation mechanism 400 and improve a reset speed.

In some embodiments, the linkage gear 300 may have a transmission tooth 370. The door opening and closing device 11 also includes a door ejection member 500 and a suspension mechanism 600. The transmission tooth 370, the door rotation mechanism 400, the door ejection member 500 and the suspension mechanism 600 are sequentially disposed at an interval on a peripheral surface of the linkage gear 300.

The transmission teeth 370 are in transmission connection with the driving mechanism 100. The door rotation mechanism 400, the door ejection member 500 and the suspension mechanism 600 are sequentially disposed on the peripheral surface of the linkage gear 300. The door rotation mechanism 400, the door ejection member 500 and the suspension mechanism 600 can be driven by one linkage gear 300 to realize functions of door ejection, door rotation and door suspension, to be capable of reducing components of the door opening and closing device 11, reducing a volume of the door opening and closing device 11, and improving an integration degree of the door opening and closing device 11.

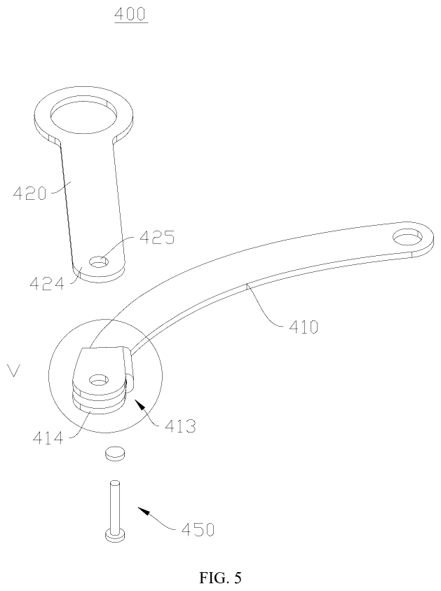

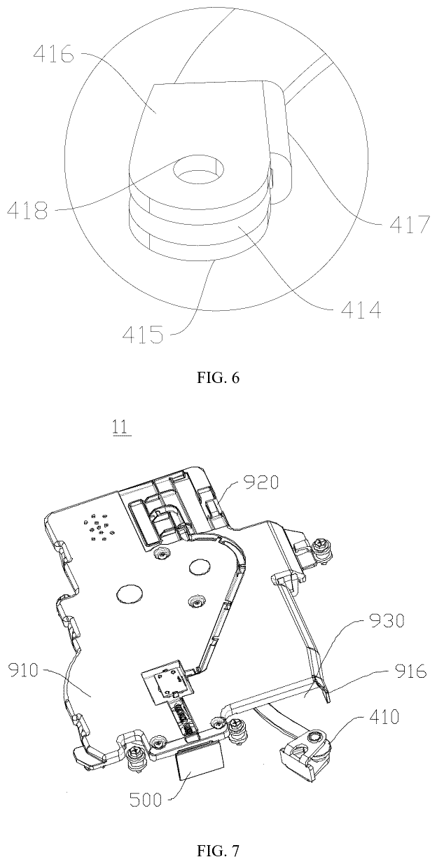

As shown in FIG. 5 and FIG. 6, in some embodiments, the door rotation mechanism 400 includes a front connecting rod 410 and a rear connecting rod 420. An end of the rear connecting rod 420 is rotatably connected to the linkage gear 300, and another end of the rear connecting rod 420 is rotatably connected to an end of the front connecting rod 410. An end of the front connecting rod 410 away from the rear connecting rod 420 is rotatably connected to the door body 13. The front connecting rod 410 and the rear connecting rod 420 are both disposed between the linkage gear 300 and the base 920.

Through a rotational cooperation of the front connecting rod 410 and the rear connecting rod 420, the space occupied by the door rotation mechanism 400 can be reduced, and the volume of the entire door opening and closing device 11 can be reduced.

In some embodiments, the front connecting rod 410 is disposed between the rear connecting rod 420 and the base 920. The rear connecting rod 420 is disposed between the front connecting rod 410 and the linkage gear 300.

The front connecting rod 410 may be disposed between the rear connecting rod 420 and the base 920. The rear connecting rod 420 may be disposed between the front connecting rod 410 and the linkage gear 300. In other words, the base 920 is disposed lowest, from a bottom to a top: the base 920, the front connecting rod 410, the rear connecting rod 420 and the linkage gear 300. The front connecting rod 410 is disposed below the rear connecting rod 420 and contacts the rear connecting rod 420. Since a hardness of the front connecting rod 410 is greater than that of the rear connecting rod 420, the front connecting rod 410 is disposed below the rear connecting rod 420, to enable the front connecting rod 410 to play a role of supporting the rear connecting rod 420. Deformations of the front connecting rod 410 and the rear connecting rod 420 can be reduced.

In some embodiments, the front connecting rod 410 has a first connecting portion 413. The rear connecting rod 420 has a second connecting portion 424. One of the first connecting portion 413 and the second connecting portion 424 has a connecting groove 414, and the other of the first connecting portion 413 and the second connecting portion 424 is engaged into the connecting groove 414.

One of the first connecting portion 413 and the second connecting portion 424 has a connecting groove 414, and another of the first connecting portion 413 and the second connecting portion 424 is engaged into the connecting groove 414. The connecting groove 414 has supporting and limiting functions and can play a role of limiting the another in multiple directions, to reduce a risk of the first connecting portion 413 separating from the second connecting part 424, and thus a fixing effect of the front connecting rod 410 and the rear connecting rod 420 is improved.

It is easily understood, as for that one of the first connecting portion 413 and the second connecting portion 424 has a connecting groove 414, it may indicate that the first connecting portion 413 has a connecting groove 414 into which the second connecting portion 424 can be engaged, or it may indicate that the second connecting portion 424 has a connecting groove 414 into which the first connecting portion 413 can be engaged. In one or more embodiments of the disclosure, for the convenience of description, a situation is taken for detailed description. In this situation, the first connecting portion 413 has a connecting groove 414 into which the second connecting portion 424 is engaged. Another situation can be analogized in which the connecting portion 424 has a connecting groove 414.

In some embodiments, under a condition that the first connecting portion 413 has a connecting groove 414, the first connecting portion 413 includes a first fixing plate 415, a second fixing plate 416 and a connecting plate 417. The first fixing plate 415 is connected to the second fixing plate 416 via the connecting plate 417. The connecting groove 414 is enclosed and formed by the first fixing plate 415, the connecting plate 417 and the second fixing plate 416. The first fixing plate 415 is connected to the front connecting rod 410.

The first fixing plate 415, the connecting plate 417 and the second fixing plate 416 can enclose and form a connecting groove 414. The connecting groove 414 is a structure with three sides open. The first connecting portion 413 is connected to an end of the front connecting rod 410. For the convenience of description, a rectangular coordinate system is established with a connection point of the first connecting portion 413 and the front connecting rod 410 as an origin point. In some embodiments, an X-axis is an extension direction of the front connecting rod 410, a Y-axis is a vertical direction, and a Z-axis is a direction vertical to both the X-axis and the Y-axis. The first fixing plate 415 and the second fixing plate 416 are spaced apart along the Y axis. The connecting plate 417 is extended along the X axis. That is, the connecting groove 414 is a through groove in the X-axis direction and has an opening in the Z-axis direction. The rear connecting rod 420 is engaged into the connecting groove 414 from an opening opposite to the connecting plate 417.

Since the rear connecting rod 420 is also in a shape of an elongated strip and is configured as a through groove in the X-axis direction, an interference between the front connecting rod 410 and the rear connecting rod 420 can be reduced when the door opening and closing device 11 drives the door body 13. Therefore, an abnormal noise caused by the interference of the front connecting rod 410 and the rear connecting rod 420 can be reduced, and a speed and effect for opening or closing the door body 13 can be improved.

In some embodiments, the connecting plate 417 is connected to a side of the first fixing plate 415 and a side of the second fixing plate 416, respectively, to increase a depth of the connecting groove 414 and enable the second connecting portion 424 of the rear connecting rod 420 to be engaged into the connecting groove 414 as completely as possible. Thus, a risk of the second connecting portion 424 separating from the connecting groove 414 can be reduced, and a fixing effect of the first connecting portion 413 and the second connecting portion 424 can be improved.

As shown in FIG. 3 and FIG. 7, in some embodiments, the door body 13 and the main body 12 are rotatably connected at a first connection point 334. The front connecting rod 410 and the door body 13 are connected at a second connection point 336. The rear connecting rod 420 and the front connecting rod 410 are rotatably connected at a third connection point 338. The second connection point 336 and the third connection point 338 are respectively located on two sides of a line connecting the first connection point 334 and the rotation center 332.

The second connection point 336 and the third connection point 338 are respectively located on two sides of the line connecting the first connection point 334 and the rotation center 332. The third connection point 338 is disposed in an area between the first connection point 334 and the rotation center 332, to make that the front connecting rod 410 and the rear connecting rod 420 move in the area between the rotation center 332 and the first connection point 334, the front connecting rod 410 and the rear connecting rod 420 are disposed closer to the rotation center 332, and the door opening and closing device 11 is disposed closer to the rotation center 332. Thus, a distance between the entire door opening and closing device 11 and the rotation center 332 can be reduced. During the door rotation mechanism 400 drives the door body 13 to rotate, an area swept by the front connecting rod 410 is smaller, and thus the entire door opening and closing device 11 is more integrated.

In some embodiments, the door opening and closing device 11 further includes a housing 900. The housing 900 has an accommodating cavity 930. The housing 900 has a throughout opening 916 in communication with the accommodating cavity 930. A driving mechanism 100, a clutch 200, the linkage gear 300 and the door rotation mechanism 400 are installed in the accommodating cavity 930. A portion of the front connecting rod 410 is extended from the throughout opening 916 to an outside of the accommodating cavity 930, and is rotatably connected to the door body 13. The second connection point 336 and the third connection point 338 are respectively located on two sides of the line connecting the first connection point 334 and the rotation center 332. The third connection point 338 is disposed in the area between the first connection point 334 and the rotation center 332. Thus, the front connecting rod 410 and the rear connecting rod 420 move in the area between the rotation center 332 and the first connection point 334. During the front connecting rod 410 drives the door body 13 to rotate, the area swept by the front connecting rod 410 on the throughout opening 916 is smaller, and thus an opening area of the throughout opening 916 can be set smaller to meet a requirement of moving space of the front connecting rod 410. A good appearance can be maintained while a structure inside the housing 900 can be stabilized. The integration degree of the entire door opening and closing device 11 can be made higher.

In some embodiments, the housing 900 may include an upper cover 910 and a base 920. The base 920 is mounted on the main body 12. The throughout opening 916 is disposed on the upper cover 910. The accommodating cavity 930 is formed by the upper cover 910 and the base 920.

The front connecting rod 410 and the rear connecting rod 420 move in the area between the rotation center 332 and the first connection point 334. In a condition that the door body 13 is closed, a line perpendicular to the door body 13 is drawn through the rotation center 332 and a line perpendicular to the door body 13 is drawn through the first connection point 334. An area between these two perpendicular lines is the area between the rotation center 332 and the first connection point 334.

It is easily understood that, under the condition that the linkage gear 300 rotates by a same angle, the closer the second connection point 336 is to the rotation center 332, the larger the angle by which the door body 13 is driven to open. Such arrangement allows the second connection point 336 to be disposed closer to the rotation center 332. A torque generated when the door opening and closing device 11 opens or closes the door body 13 is greater. The linkage gear 300 can rotate by a smaller angle to drive the door body 13 to rotate by a larger angle, to make the door opening and closing device 11 more flexible.

With the door opening and closing device 11 according to one or more embodiments of the disclosure, during the linkage gear 300 drives the door rotation mechanism 400 to rotate, the door rotation mechanism 400 is disposed between the linkage gear 300 and the base 920. The linkage gear 300 and the base 920 can limit the door rotation mechanism 400 from two sides of the door rotation mechanism 400, to enable the door rotation mechanism 400 to rotate in a gap between the linkage gear 300 and the base 920 to open or close the door body 13. The linkage gear 300 and the base 920 can limit the door rotation mechanism 400 from two sides of the door rotation mechanism 400, to be capable of reducing a risk of the door rotation mechanism 400 separating from the linkage gear 300, and improving a transmission stability of the linkage gear 300 and the door rotation mechanism 400.

As shown in FIG. 1 and FIG. 2, an electrical apparatus 10 is also provided according to an embodiment of the disclosure, including a door body 13, a main body 12 and the above-mentioned door opening and closing device 11. The door body 13 is rotatably connected to the main body 12. The door opening and closing device 11 is installed on the main body 12. The front connecting rod 410 is connected to the door body 13.

In some embodiments, the electrical apparatus 10 may be a household appliance such as a refrigerator, a dishwasher, or a disinfection cabinet.

In the description of this specification, the description with reference to the terms “one embodiment”, “some embodiments”, “example”, “specific example”, or “some examples” and so on means that the specific features, structures, materials or characteristics described in conjunction with the embodiment or example are included in at least one embodiment or example of the disclosure. In the specification, the exemplary expressions of the above terms do not necessarily refer to the same embodiment or example. Furthermore, the specific features, structures, materials, or characteristics described may be combined in any suitable manner in any one or more embodiments or examples.

1. A door opening and closing device, for opening a door body disposed on a main body, comprising:
a base;
a driving mechanism;
a linkage gear rotatably disposed on the base and in transmission connection with the driving mechanism;
a door rotation mechanism disposed between the linkage gear and the base, an end of the door rotation mechanism being connected to the linkage gear, another end of the door rotation mechanism being connected to the door body, wherein in a condition that the driving mechanism drives the linkage gear to rotate, the door rotation mechanism drives the door body to rotate relative to the main body, to open or close the door body.

2. The door opening and closing device according to claim 1, wherein a side of the linkage gear facing the base is provided with an installation groove, the door rotation mechanism being installed in the installation groove.

3. The door opening and closing device according to claim 2, wherein a width of the installation groove is greater than that of the door rotation mechanism.

4. The door opening and closing device according to claim 3, wherein the linkage gear has a first abutting-holding surface, and wherein in a condition that the driving mechanism drives the linkage gear to rotate, the linkage gear rotates relative to the door rotation mechanism until the first abutting-holding surface abuts against and holds the door rotation mechanism, and the linkage gear pushes the door rotation mechanism to rotate to open the door body.

5. The door opening and closing device according to claim 4, wherein the linkage gear further has a second abutting-holding surface spaced apart from the first abutting-holding surface, the door rotation mechanism being disposed between the first abutting-holding surface and the second abutting-holding surface, and wherein the door opening and closing device further comprises a reset member, the reset member being connected to the linkage gear and the door rotation mechanism, respectively, and wherein in a condition that the linkage gear stops rotating or rotates reversely, the reset member drives the door rotation mechanism to move in a direction away from the first abutting-holding surface, to reset the door rotation mechanism to the second abutting-holding surface.

6. The door opening and closing device according to claim 5, wherein a fixing slot is disposed on the linkage gear, the reset member being disposed in the fixing slot.

7. The door opening and closing device according to claim 5, wherein a side of the linkage gear facing the base is provided with the installation groove, the door rotation mechanism being installed in the installation groove, the first abutting-holding surface and the second abutting-holding surface being disposed on two opposite side walls of the installation groove.

8. The door opening and closing device according to claim 1, wherein the door rotation mechanism comprises a front connecting rod and a rear connecting rod, an end of the rear connecting rod being rotatably connected to the linkage gear, another end of the rear connecting rod being rotatably connected to an end of the front connecting rod, an end of the front connecting rod away from the rear connecting rod being rotatably connected to the door body, the front connecting rod and the rear connecting rod being both disposed between the linkage gear and the base.

9. The door opening and closing device according to claim 8, wherein the front connecting rod is disposed between the rear connecting rod and the base, the rear connecting rod being disposed between the front connecting rod and the linkage.

10. The door opening and closing device according to claim 8, wherein the front connecting rod has a first connecting portion, and wherein the rear connecting rod has a second connecting portion, one of the first connecting portion and the second connecting portion having a connecting groove, the other of the first connecting portion and the second connecting portion being engaged into the connecting groove.

11. The door opening and closing device according to claim 8, wherein the door body and the main body are rotatably connected at a first connection point, and wherein the front connecting rod and the door body are connected at a second connection point, and wherein the rear connecting rod and the front connecting rod are rotatably connected at a third connection point, the second connection point and the third connection point being respectively located on two sides of a line connecting the first connection point and a rotation center.

12. The door opening and closing device according to claim 1, wherein the linkage gear has a transmission tooth, and wherein the door opening and closing device further comprises a door ejection member and a suspension mechanism, and wherein the transmission tooth, the door rotation mechanism, the door ejection member and the suspension mechanism are sequentially disposed at an interval on a peripheral surface of the linkage gear.

13. An electrical apparatus, comprising a door body 13, a main body, and the door opening and closing device according to claim 1, the door body being rotatably connected to the main body, the door opening and closing device being installed on the main body, the door rotation mechanism being connected to the door body.
